(19) United States
(12) Patent Application Publication
(10) Pub. No.: US 2005/0258095 A1
(43) Pub. Date: Nov. 24, 2005

(54) Enzyme-assisted clarification and dewatering of wastewater

(76) Inventors: Jawed Sarkar, Naperville, IL (US); Michael Braden, Sugar Land, TX (US); Jitendra Shah, Naperville, IL (US)

Correspondence Address: NALCO COMPANY, 1601 W. DIEHL ROAD, NAPERVILLE, IL, 60563-1198, US

(21) Appl. No.: 10/764,684

(22) Filed: Jan. 23, 2004

Related U.S. Application Data
(63) Continuation-in-part of application No. 10/059,473, filed on Jan. 29, 2002, now Pat. No. 6,733,673.
(63) Continuation-in-part of application No. 10/347,891, filed on Jan. 22, 2003, now Pat. No. 6,733,674.

(51) Int. Cl. C02F 1/00

(52) U.S. Cl. 210/632

(57) ABSTRACT

A method of clarifying and dewatering wastewater comprising adding an effective clarifying and dewatering amount of one or more cellulolytic enzymes and one or more flocculants to the sludge to form a mixture of water and coagulated and flocculated solids and separating the coagulated and flocculated solids from the water.

### CROSS REFERENCE TO RELATED APPLICATIONS

This is a continuation in part of Ser. No. 10/059,473, filed Jan. 29, 2002 and a continuation in part of Ser. No. 10/347,891, filed Jan. 22, 2003.

### TECHNICAL FIELD

This invention concerns the use of cellulolytic enzyme preparations in combination with one or more flocculants to aid in clarifying and dewatering municipal and industrial wastewater.

### BACKGROUND OF THE INVENTION

The dewatering and clarification of municipal and industrial sludges containing suspended organic solids is typically accomplished by mixing the sludge with one or more chemical reagents in order to induce a state of coagulation or flocculation of the solids which are then separated from the water using mechanical devices such as plate and frame filter presses, belt-filter presses, centrifuges, and the like.

For example, in a typical municipal sewage plant, wastewater remaining after coarse solids are settled out of the incoming sewage influent is conveyed into a biological clarifying stage, where the dissolved and suspended organic material is decomposed by microorganisms in the presence or absence of air. These processes are referred to as aerobic digestion and anaerobic digestion, respectively.

The organic matter obtained as a result of this decomposition is largely bound in the form of a mass of microorganisms. This mass is precipitated as an activated sludge. The water may be released into waterways or allowed to seep away in sewage irrigation fields, but the activated sludge must be dewatered prior to disposal.

Moreover, variations often occur in wastewater from any one source, leading to a variety of particle types which must be removed. For example, municipal sludge consists of primary and waste-activated sludges. The sludges typically contain a considerable amount of cellulose, arising from paper, rags and vegetable fibers. Cellulose accounts for 60 to 80 percent of the total carbohydrate and 15 to 25 percent of the total organic particulate. Municipal sludges generally contain a large proportion of sanitary wastewater from one or more residential communities. The influent is generally of a more biological nature in municipal sludges.

Industrial sludges, on the other hand, come from a variety of industries including paper, refinery, chemical, steel, aluminum and others. Primary solids vary considerably from industry to industry. In some industrial sludge from the refinery and chemical industries, very low amounts of primary solids are present. Most of the solids are from the waste-activated sludge process. The influent to an industrial wastewater plant is mainly process effluents, and it usually contains a lot of organic material. Steel and aluminum industrial sludge may contain steel and aluminum and some oils, whereas paper mill influent contains a very large proportion of fibers and solids from the process. The composition of industrial sludge is very different than that of municipal sludge and is quite specific to the industry. The nature of solids and content of solids can also vary greatly depending on the type of industries. The organics loading is generally higher in industrial influent than in municipal influent.

More particularly, in refineries, the primary wastewater treatment facilities remove most of the insoluble oils that come from the process units upstream of the wastewater treatment plant (WWTP). The contaminants are components of crude oils: paraffins, asphaltenes, aromatic hydrocarbons (including benzene, toluene, xylenes, etc.), aliphatic hydrocarbons, hydrogen sulfides, cyanate salts, ammonia, soaps and detergents, and methanol from deep offshore oilfields. The secondary or biological treatment facility must remove the water-soluble contaminants from the above list.

In the Chemical Processing Industry (CPI), the organics sent to the WWTP are more refined and thus more water-soluble and difficult to remove at the primary WWTP. The hydrocarbons are more refined and functionalized, e.g. manufactured amines, esters, ethers, carboxylic acids, lactones, lactams, etc. These functionalized hydrocarbons are more water-soluble, and thus the biological treatment program is under duress and stress to remove the contaminants prior to discharge.

For the steel and aluminum industries, the hydrocarbons going to the wastewater treatment plant consist of highly functionalized materials. Heavy greases and lubricants are used as well as greater amounts of surfactants designed to create oil-in-water emulsions. Furthermore, metal solids from the process, such as iron oxides and aluminum oxides, are present in higher quantities and help stabilize oil contamination in water.

The objective of clarification and dewatering processes is to maximize the efficiency of water removal, as decreasing the amount of water retained in the dewatered solids leads to decreased transport and disposal costs. Therefore, there is an ongoing need for improved clarification and dewatering technologies that are suitable for use across the spectrum of wastewaters.

Dewatering of biologically clarified sludges using a hydrolytic enzyme preparation containing cellulases followed by a high molecular weight cationic flocculant is disclosed in European Patent No. 291 665.

Dewatering of sludges using cellulolytic enzyme preparations in combination with enzymatic or chemical oxidants followed by a high molecular weight flocculant is disclosed in commonly-owned U.S. patent application Ser. Nos. 10/059,473 and 10/347,891, now U.S. Pat. Nos. ______ and ______, respectively.

### SUMMARY OF THE INVENTION

This invention is a method of clarifying and dewatering industrial wastewater comprising sequentially
i) adding an effective amount of one or more cellulolytic enzymes to the wastewater;
ii) adding an effective amount of one or more flocculants to the wastewater to form a mixture of water and coagulated and flocculated solids; and
iii) separating the coagulated and flocculated solids from the water.

Benefits of using enzymes as described herein in wastewater treatment include polymer dosage reduction, cake dryness improvement, improved settling of sludge, better filtrate quality from the dewatering operation and faster wastewater clarification.

### DETAILED DESCRIPTION OF THE INVENTION

Cellulolytic enzymes refers to a class of enzymes involved in hydrolyzing cellulose and other water-soluble cyclodextrins. The enzymes are found in natural processes via biological operations or are synthesized by a variety of microorganisms including fungi, actinomycetes, myxobacteria and true bacteria and also by plants. The specific enzymes can also be engineered by a specific type of biological operation or by purification.

The cellulolytic enzyme preparations used in the practice of this invention are commercially available enzymes obtained from microorganism cultures. The preparations may contain a single cellulolytic enzyme or mixture of cellulolytic enzymes. Additional hydrolytic enzymes including proteases, glycoproteinases, lipases, alpha-amylases, β-glucanases, hemicellulases, laminarinases, and the like may also be present as impurities in the enzyme preparation.

Cellulolytic enzymes useful in the practice of this invention include one or more cellulases present in the enzyme system that hydrolyzes cellulose to glucose including cellobiohydrolase (1,4-β-D-glucan cellobiohydrolase, EC 3.2.1.91), including endo-1,4-β-glucanase (endo-1,4-β-D-glucan 4-glucanohydrolase, EC 3.2.1.4), exo-1,4-β-glucanase and β-glucosidase (EC 3.2.1.21).

In a preferred aspect of this invention, the cellulolytic enzyme is a mixture of endo-1,4-β-glucanase, exo-1,4-β-glucanase and 1,4-β-glucosidase.

In another preferred aspect, the cellulolytic enzyme is a mono-component enzyme preparation having only endoglucanase activity.

In another preferred aspect, the mono-component enzyme preparation comprises endo-1,4-β-glucanase.

Enzyme preparations having only endoglucanase activity useful in the practice of this invention are described in U.S. Pat. Nos. 6,001,639 and 6,387,690, incorporated herein by reference.

The cellulolytic enzyme preparations are generally available as solutions in water, which can be further diluted. In the process of this invention, aqueous solutions having an enzyme concentration of from about 0.01 to about 100 grams of enzyme protein per liter are typically used.

In a preferred aspect of this invention, the wastewater is an industrial sludge.

In another preferred aspect, the industrial sludge is an activated sludge.

A particular type of sludge is an autothermal (or autoheated) thermophilic aerobic digestion (ATAD) sludge. ATAD refers to an aerobic sludge digestion process that operates in the thermophilic temperature range (about 40° C. to about 80° C.) with supplemental heat. The ATAD process may be used on both industrial and municipal sludges.

The thermophilic bacteria that flourish at the elevated temperatures used in the ATAD process have a much higher rate of metabolism, which results in a much faster rate of volatile solids destruction compared to anaerobic digestion operating in the mesophilic range, or conventional aerobic digestion operating near ambient wastewater temperatures. Adequate volatile solids destruction (about 35-45 percent) is achieved in an ATAD system in about 6-8 days, compared to about 30-60 days in an anaerobic digester or about 20-60 days in an aerobic digester. Additionally, the elevated temperatures in an ATAD system are effective in destroying pathogens, with pathogen reduction to non-detectable levels being achieved within about five hours at temperatures of 50° C. or better. Thus, ATAD requires not only less tankage but will produce a Class A sludge, whereas conventional aerobic and anaerobic digestion will produce only Class B sludge due to the pathogen content in municipal sludges.

ATAD sludge, however, is difficult to dewater. Experience from full-scale operations show that ATAD results in deterioration of biosolids dewatering properties, and increased costs of biosolids conditioning. ATAD also results in smaller and finer biosolids flocs that may contribute to the deteriorated dewaterability and increased demands of conditioning polymers.

Furthermore, thermophilic bacteria produce various biopolymers such as polysaccharides, starch, proteins and lipoglycoproteins. These materials can soak up water like a sponge and inhibit the release of the water. Chemical treatment involves using high molecular weight cationic polymers and the use of various dewatering equipment including belt presses, centrifuges, screw presses, plate and frame filter presses and gravity belt thickeners. In most cases, either chemical or equipment processes cannot completely force the water from the biopolymers. Thus the percent solids are typically lower for ATAD sludges. We have discovered that enhanced dewatering of ATAD sludges can be attained by using cellulolytic enzymes in combination with polymeric flocculants. Accordingly, in another preferred embodiment, the sludge is an autothermal thermophilic aerobic digestion sludge.

We have also discovered treating of municipal or industrial wastewater with a mono-component enzyme preparation having only endoglucanase activity confers additional benefits over treatment with a multi-component cellulolytic enzyme preparation, particularly a reduction in BOD (biological oxygen demand) of the resulting sludge over sludge that results from treatment of the wastewater with multi-component enzyme.

Accordingly, in another preferred aspect, this invention is a method of clarifying wastewater comprising sequentially
i) adding an effective amount of a mono-component enzyme preparation having only endoglucanase activity to the wastewater;
ii) adding an effective amount of one or more flocculants to the wastewater to form a mixture of water and coagulated and flocculated solids; and
iii) separating the coagulated and flocculated solids from the water.

In another preferred aspect, the wastewater is selected from the group consisting of municipal sludge and industrial sludge.

In a preferred aspect, the sludge is an activated sludge.

In another preferred aspect, the mono-component enzyme preparation comprises endo-1,4-β-glucanase.

In another preferred aspect, the sludge is an autothermal thermophilic aerobic digestion sludge.

In a typical application, about 0.125 to about 5 L/dry ton, preferably about 0.125 to about 1 L/dry ton of the enzyme preparation is added under well mixed conditions to the wastewater. The enzyme treatment is carried out at ambient process water temperature without further temperature adjustment, noting however, that the process water temperatures are typically higher than ambient temperature, often as warm as 60° C. As noted above, ATAD processes can operate at a temperature up to about 80° C. Mixing is continued for several minutes to several days, preferably about 30 minutes to about 6 days, after which time the flocculants and any coagulants are added. The wastewater is then mechanically dewatered, for example by devices such as plate and frame filter presses, belt-filter presses, centrifuges, and the like.

Suitable flocculants for use in this invention generally have molecular weights in excess of 1,000,000 and often 20,000,000. The polymeric flocculant is typically prepared by vinyl addition polymerization of one or more cationic monomers, by copolymerization of one or more cationic monomers with one or more nonionic monomers, by polymerization of one or more cationic monomers with one or more anionic monomers and optionally one or more nonionic monomers to produce an amphoteric polymer, by polymerization of one or more anionic monomers or by copolymerization of one or more anionic monomers with one or more nonionic monomers.

While cationic polymers may be formed as cationic polymers, it is also possible to react certain non-ionic vinyl addition polymers to produce cationically charged polymers. Polymers of this type include those prepared through the reaction of polyacrylamide with dimethylamine and formaldehyde to produce a mannich derivative.

The flocculant may be used in the solid form, as an aqueous solution, as a water-in-oil emulsion, or as a dispersion in water. Representative cationic polymers include copolymers and terpolymers of (meth)acrylamide with dimethylaminoethyl methacrylate (DMAEM), dimethylaminoethyl acrylate (DMAEA), diethylaminoethyl acrylate (DEAEA), diethylaminoethyl methacrylate (DEAEM) or their quaternary ammonium forms made with dimethyl sulfate, methyl chloride or benzyl chloride. A preferred cationic flocculant is dimethylaminoethylacrylate methyl chloride quaternary salt/acrylamide copolymer.

Representative anionic polymers include homopolymers of (meth)acrylic acid and its salts and copolymers of (meth)acrylic acid and salts thereof with (meth)acrylamide. A preferred anionic flocculant is acrylic acid/acrylamide copolymer.

The dose of flocculant depends on the properties of the sludge being treated and can be empirically determined by one of skill in the art. In general, the flocculant polymer dose is from about 50 ppm to about 5000 ppm, preferably from about 100 to about 1000 ppm, based on polymer solids, per dry ton solids.

In another preferred aspect, one or more coagulants are added to the wastewater after the enzyme treatment.

Water-soluble coagulants are well known, and commercially available. Suitable coagulants include polymeric coagulants and inorganic coagulants such as aluminum chloride, ferric chloride, ferric sulfate, and the like. Inorganic coagulants are preferred for dewatering of ATAD sludges.

Many water-soluble polymeric coagulants are formed by condensation polymerization. Examples of polymers of this type include epichlorohydrin-dimethylamine, and epichlorohydrin-dimethylamine-ammonia polymers.

Additional polymeric coagulants include polymers of ethylene dichloride and ammonia, or ethylene dichloride and dimethylamine, with or without the addition of ammonia, condensation polymers of multifunctional amines such as diethylenetriamine, tetraethylenepentamine, hexamethylenediamine and the like with ethylenedichloride and polymers made by condensation reactions such as melamine formaldehyde resins.

Additional polymeric coagulants include cationically charged vinyl addition polymers such as polymers and copolymers of diallyldimethylammonium chloride, dimethylaminoethylmethacrylate, dimethylaminomethylmethacrylate methyl chloride quaternary salt, methacrylamidopropyltrimethylammonium chloride, (methacryloxyloxyethyl)trimethyl ammonium chloride; diallylmethyl(β-propionamido)ammonium chloride; (β-methacryloxyloxyethyl)trimethyl-ammonium methylsulfate; quaternized polyvinyllactam; dimethylamino-ethylacrylate and its quaternary ammonium salts; and acrylamide or methacrylamide which has been reacted to produce the mannich or quaternary mannich derivative. The molecular weights of these cationic polymers, both vinyl addition and condensation, range from as low as several hundred to as high as one million. Preferably, the molecular weight range should be from about 20,000 to about 1,000,000.

The foregoing may be better understood by reference to the following examples, which are presented for purposes of illustration and are not intended to limit the scope of the invention.

### EXAMPLE 1

Dewatering of a Chemical Industry Sludge with a Mono-Component Enzyme Preparation having Only Endoglucanase Activity.

A sample of mixed sludge from a large, midwestern chemical plant is obtained. The sludge is from a thickener and is taken prior to dewatering. The sludge has a suspended solids concentration of 6.5%. The sludge mixture consists of 60% secondary and 40% primary sludge. Two beakers containing 2000 grams of sludge are prepared. In one beaker, the sludge sample is mixed with 0.5 L of mono-component cellulolytic enzyme (endo-1,4-β-glucanase, EC 3.2.1.4, optimum pH range 5.5-7.5, available from Novozymes A/S, Bagsvaerd, Denmark under the designation NS-51008) per dry ton of sludge solids. In the second beaker, an equivalent amount of demineralized water is added to equalize the volume. The two beakers are maintained at 32° C. using a water bath and the contents are well mixed by a mechanical mixer stirring at 100 RPM. At the end of 48 hours, each sample is conditioned with a cationic polymer solution (40 mole percent dimethylaminoethylacrylate methyl chloride quaternary salt/acrylamide latex copolymer, RSV 12-19, available from Nalco Company, Naperville, Ill.) at several dosages. The conditioned samples are drained using filter media, and the rate of filtration is measured as a function of time. This test is commonly used to evaluate the effect of additives on the rate of filtration. The results are shown in Table 1. As can be seen, the rate of filtration is significantly better in the sample with the mono-component cellulolytic enzyme added compared to the control sample, especially at 250 and 275 ppm of cationic polymer.

TABLE 1
Effect of a mono-component cellulolytic enzyme on drainage

| | | | 10 sec |
|---|---|---|---|
| | Cationic | 10 sec | Mono Component |
| Volume (mL) | Polymer (ppm) | control (ml) | Enzyme (ml) |
| 8 | 200 | 32.7 | 36.0 |
| 10 | 250 | 39.7 | 66.1 |
| 11 | 275 | 48.7 | 56.4 |
| 12 | 300 | 63.5 | 68.0 |

### EXAMPLE 2

Dewatering of a Chemical Industry Sludge with a Multi-Component Cellulolytic Enzyme Preparation.

A sample of mixed sludge from a large southern petrochemical plant is obtained. The sludge is a blend of 1:1 digester influent and effluent. The sludge has a suspended solids concentration of 3.5%. The sludge mixture consists of 70% secondary and 30% primary sludge. Two containers, each holding 5000 grams of sludge, are prepared. In one container, the sludge sample is mixed with 0.5 L per dry ton of multi-component cellulolytic enzyme preparation containing cellulases, hemicellulases, xylanases (EC 3.2.1.8) and pentosanases (SP-342, available from Novozymes A/S, Bagsvaerd, Denmark). In the second container, an equivalent amount of demineralized water is added to equalize the volume. The two containers are maintained at 32° C. using a heater and the contents are well mixed with a mechanical mixer stirring at 100 RPM. The contents are kept under anaerobic conditions. At the end of five days, each sample is conditioned with a cationic polymer solution (50 mole percent dimethylaminoethylacrylate methyl chloride quaternary salt/acrylamide latex copolymer, RSV 8-12, available from Nalco Company, Naperville, Ill.) at several dosages. The conditioned samples are drained using a filter media, and the rate of filtration is measured as a function of time. This test is commonly used to evaluate the effect of additives on the rate of filtration. The results are shown in Table 2. As can be seen, the rate of filtration is significantly better in the sample with the multi-component cellulolytic enzyme added compared to the control.

TABLE 2
Effect of a multi-component cellulolytic enzyme on drainage

| | Cationic | | | | | | |
|---|---|---|---|---|---|---|---|
| | Polymer | Cationic | 5 | 10 | 15 | 30 | 60 |
| | Solution | Polymer | sec | sec | sec | sec | sec |
| Sludge | (ml) | (ppm) | (ml) | (ml) | (ml) | (ml) | (ml) |
| Control | 12 | 300 | 34 | 40 | 44 | 50 | 70 |
| Control | 13 | 325 | 46 | 56 | 66 | 80 | 104 |
| Multi | 12 | 300 | 46 | 54 | 66 | 78 | 94 |
| Component | | | | | | | |
| Multi | 13 | 325 | 54 | 66 | 74 | 88 | 102 |
| Component | | | | | | | |

### EXAMPLE 3

Dewatering of ATAD Sludge with a Mono-Component Enzyme Preparation Having Only Endoglucanase Activity.

The enzyme treatment is conducted on a 1:3 blend of sludge from the gravity belt thickener (GBT) and autothermal thermophilic aerobic digestion (ATAD) holding tank from a southern CPI plant. The sample is divided, and each 4-L portion is placed into a 5-L, four-necked, round-bottom flask fitted with an overhead stirrer, thermometer probe, air inlet and condenser. For each flask, air is introduced via the air inlet, and the sample is agitated to ensure thorough mixing and heated to 140° F. The sludge has a solids concentration of 3.64% and consists of 25% GBT sludge and 75% ATAD sludge. To one of the flasks marked “Treated” is added 0.5 L per dry ton of mono-component cellulolytic enzyme (endo-1,4-β-glucanase, EC 3.2.1.4, optimum pH range 5.5-7.5, available from Novozymes A/S, Bagsvaerd, Denmark, under the designation NS-51008). In the second beaker, an equivalent amount of demineralized water is added to equalize the volume. The experiment lasts 14 days to duplicate the retention time of the ATAD system.

At the end of 14 days, the sludge is dewatered using ferric sulfate at various dosages and anionic flocculant (50 mole percent anionic charge dry polymer, 90% actives, available from Nalco Company, Naperville, Ill.) at 100 ppm. Free drainage is recorded at 5, 10, 15 and 30 seconds, and the 10-second data is graphed (see Table 3). The data is shown below. Using the enzyme material, more free water is released at lower dosages of ferric sulfate, significantly reducing the coagulant dosage by at least 75%.

TABLE 3
Effect of mono-component enzyme
on free drainage of ATAD sludge.

| | Dosage of Ferric Sulfate, ppm | | | | | | | | |
|---|---|---|---|---|---|---|---|---|---|
| | (free drainage recorded at 10 seconds) | | | | | | | | |
| | 2000 | 4000 | | 6000 | | 8000 | | 10000 | |
| Treated | 110 mL | 125 | mL | 120 | mL | 110 | mL | 80 | mL |
| Untreated | | 30 | mL | 80 | mL | 90 | mL | 105 | mL |

### EXAMPLE 4

Dewatering of Municipal Sludge with a Mono-Component Enzyme Preparation Having Only Endoglucanase Activity.

A sample of mixed sludge from a large midwestern municipal plant is obtained. The sludge is from an anaerobic digester and is taken prior to dewatering. The sludge has a suspended solids concentration of 2.3%. Two plastic bottles containing 2000 grams of sludge are prepared. In one bottle, the sludge sample is mixed with 0.5 L per dry ton of mono-component cellulolytic enzyme (endo-1,4-β-glucanase, EC 3.2.1.4, optimum pH range 5.5-7.5, available from Novozymes A/S, Bagsvaerd, Denmark, under the designation NS-51008). In the second beaker, an equivalent amount of demineralized water is added to equalize the volume. The two bottles are mixed at 100 RPM and maintained at 32° C. using incubator shaker equipment. At the end of 120 hours, each sample is conditioned with a cationic polymer solution (50 mole percent dimethylaminoethylacrylate methyl chloride quaternary salt/acrylamide latex copolymer, RSV 18-23, available from Nalco Company, Naperville, Ill.) at several dosages. The conditioned samples are drained using filter media, and the rate of filtration is measured as a function of time. This test is commonly used to evaluate the effect of additives on the rate of filtration. The results are shown in Table 4. As can be seen, the rate of filtration is significantly better in the sample with the mono-component cellulolytic enzyme added compared to the control sample.

TABLE 4
Effect of a mono-component cellulolytic
enzyme on municipal sludge drainage

| | | | 10 sec |
|---|---|---|---|
| | Cationic | 10 sec | Mono-Component |
| Volume (ml) | Polymer (ppm) | control (ml) | Enzyme (ml) |
| 5 | 125 | 18.1 | 40.0 |
| 7 | 175 | 81.4 | 115.1 |
| 7.5 | 187.5 | 94.2 | 138.3 |
| 8 | 200 | 120.4 | 147.7 |

### EXAMPLE 5

Clarification of Refinery Wastewater Using a Mono-Component Enzyme Preparation Having Only Endoglucanase Activity.

The enzyme treatment is conducted on a 2:1 blend of sludge from the aeration basin influent and secondary clarifier recycle from a refinery wastewater treatment system. The suspended solids concentration is 1.2%. The sample is divided and each 4-L portion is placed into a 5-L, four-necked, round bottom flask fitted with an overhead stirrer, thermometer probe, air inlet and condenser. For each flask, air is introduced via the air inlet, and the sample is agitated to ensure thorough mixing and heated to 30° C. To one of the flasks marked “Treated” is added 0.5 L per dry ton of mono-component cellulolytic enzyme (endo-1,4-β-glucanase, EC 3.2.1.4, optimum pH range 5.5-7.5, available from Novozymes A/S, Bagsvaerd, Denmark, under the designation NS-51008). In the second beaker, an equivalent amount of demineralized water is added to equalize the volume. The experiment lasts 12 hours to duplicate the retention time of the aeration basin and secondary clarifier process.

At the end of 12 hours, 1-L of sludge from each reactor is placed in a 1-L graduated cylinder. Cationic polymer (10 ppm, 30 mole percent dimethylaminoethylacrylate methyl chloride quaternary salt/acrylamide latex copolymer, RSV 18-25, available from Nalco Company, Naperville, Ill.) is added and each cylinder is inverted six times to simulate the transfer of sludge from the aeration basin to the clarifier. The amount of free water (because of settling) is measured in milliliters (mL) at various times. As shown in Table 5, the enzyme-treated sludge settled more quickly and had less sludge volume than an untreated sample.

TABLE 5
Effect of mono-component cellulolytic
enzyme on wastewater clarification.

| | 5 min | 10 min | 15 min | 30 min |
|---|---|---|---|---|
| | 10 ppm cationic polymer | | | |
| Treated | 400 | 540 | 590 | 660 |
| Untreated | 30 | 80 | 130 | 330 |
| | 20 ppm cationic polymer | | | |
| Treated | 410 | 520 | 550 | 610 |
| Untreated | 100 | 240 | 310 | 410 |
| | 30 ppm cationic polymer | | | |
| Treated | 200 | 475 | 475 | 500 |
| Untreated | 100 | 200 | 220 | 280 |

Changes can be made in the composition, operation and arrangement of the method of the invention described herein without departing from the concept and scope of the invention as defined in the claims.

1. A method of clarifying and dewatering an industrial wastewater comprising sequentially
i) adding an effective amount of one or more cellulolytic enzymes to the wastewater;
ii) adding an effective amount of one or more flocculants to the wastewater to form a mixture of water and coagulated and flocculated solids; and
iii) separating the coagulated and flocculated solids from the water.

2. The method of claim 1 wherein wastewater is an industrial sludge.

3. The method of claim 2 wherein the industrial sludge is an activated sludge.

4. A method of dewatering an autothermal thermophilic aerobic digestion sludge comprising
i) adding an effective amount of one or more cellulolytic enzymes to the sludge:
ii) adding an effective amount of one or more flocculants to the sludge to form a mixture of water and coagulated and flocculated solids; and
iii) separating the coagulated and flocculated solids from the water.

5. The method of claim 1 wherein the cellulolytic enzymes comprise a mixture of endo-1,4-β-glucanase, exo-1,4-β-glucanase and 1,4-β-glucosidase.

6. The method of claim 1 wherein the cellulolytic enzyme is a mono-component enzyme preparation having only endoglucanase activity.

7. The method of claim 6 wherein the mono-component enzyme preparation comprises endo-1,4-β-glucanase.

8. The method of claim 4 wherein the cellulolytic enzyme is a mono-component enzyme preparation having only endoglucanase activity.

9. The method of claim 8 wherein the mono-component enzyme preparation comprises endo-1,4-β-glucanase.

10. The method of claim 2 wherein the cellulolytic enzyme is a mono-component enzyme preparation having only endoglucanase activity.

11. The method of claim 10 wherein the mono-component enzyme preparation comprises endo-1,4-β-glucanase.

12. The method of claim 1 further comprising adding one or more coagulants to the wastewater.

13. The method of claim 9 further comprising adding one or more coagulants to the wastewater.

14. A method of clarifying and dewatering wastewater comprising sequentially
i) adding an effective amount of a mono-component enzyme preparation having only endoglucanase activity to the wastewater;
ii) adding an effective amount of one or more flocculants to the wastewater to form a mixture of water and coagulated and flocculated solids; and
iii) separating the coagulated and flocculated solids from the water.

15. The method of claim 14 wherein the wastewater us selected from the group consisting of municipal sludge and industrial sludge.

16. The method of claim 15 wherein the sludge is an activated sludge.

17. The method of claim 14 wherein the mono-component enzyme preparation comprises endo-1,4-β-glucanase.

18. The method of claim 15 wherein the sludge is an autothermal thermophilic aerobic digestion sludge.

19. The method of claim 14 further comprising adding one or more coagulants to the wastewater.

20. The method of claim 18 further comprising adding one or more coagulants to the sludge.
